(19) United States
(12) Patent Application Publication
(10) Pub. No.: US 2016/0232303 A1
(43) Pub. Date: Aug. 11, 2016

(54) AUTOMATICALLY HANDLING NATURAL-LANGUAGE PATIENT INQUIRIES ABOUT HEALTH INSURANCE INFORMATION

(71) Applicant: Sensentia, Inc., San Francisco, CA (US)

(72) Inventors: Ronen Amit, Tel Aviv (IL); Jan Jungclaus, San Francisco, CA (US); Peter Stephenson, Miami, FL (US)

(21) Appl. No.: 15/017,516

(22) Filed: Feb. 5, 2016

Related U.S. Application Data
(60) Provisional application No. 62/112,319, filed on Feb. 5, 2015.

(51) Int. Cl. G06F 19/00; G06F 17/30; G10L 13/027

(52) U.S. Cl. CPC G06F 19/322; G10L 13/027; G06F 17/30401

(57) ABSTRACT

A system for responding to natural-language inquiries is described. The system accesses a textual natural language inquiry originated by a user. For each of one or more inquiry attributes, the system extracts from the textual natural language query a value for the inquiry attribute. The system uses the extracted inquiry attribute values to construct one or more HIPAA requests seeking information relevant to the inquiry. The system submits the constructed requests to a payer computer system. In response to submission of the constructed requests, the system receives from a payer computer system one or more HIPAA responses. Using information contained by at least one of the received HIPAA responses, the system generates a textual natural language response.

### CROSS-REFERENCE TO RELATED APPLICATION(S)

This application claims the benefit of U.S. Provisional Patent Application No. 62/112,319 filed on Feb. 5, 2015, which is hereby incorporated by reference in its entirety.

### BACKGROUND

Patients enrolled in a health insurance plan may seek information about their eligibility to receive benefits for medical services, and the benefits they are entitled to when receiving such medical services. Such eligibility and benefits information may include the plan's deductible(s), out-of-pocket limit(s), exclusions, co-payment(s), co-insurance(s), limits applying to specific medical services, and more. Patients may need such information in order to utilize their health insurance plan effectively, and manage their health, healthcare and finances properly.

Currently, patients seeking such eligibility and benefits information have two options. The first option is to independently search for the sought information in their specific health plan's documentation, such as the health plan's Evidence of Coverage (EOC) document, Explanation of Benefits (EOB) document or other related policy documents. The second option is to call the health insurer's customer care center and ask a call center representative for the information.

### BRIEF DESCRIPTION OF DRAWINGS

FIG. 1 is a high-level architecture of a possible embodiment of the system where user inquiries as well as the answers to these inquiries are in a textual format.

FIG. 2 illustrates a flow chart diagram of a method for providing an answer to a natural language eligibility and benefits inquiry using HIPAA transactions.

FIGS. 2A and FIG. 2B illustrate parts of FIG. 2 in more detail.

FIG. 2C illustrates a possible embodiment of the system where part of the process, illustrated in FIG. 2A, is performed in a different way.

FIG. 3 is a high-level architecture of a possible embodiment of the system where user inquiries may be spoken and the answers to these inquiries may be in a speech format.

FIG. 4 is a high-level architecture of a possible embodiment of the system where the system is used to obtain claim status information using additional types of HIPAA transactions.

FIG. 5 is a high level architecture of possible embodiments specifying the different interaction modes that users can use in order to interact with the System.

FIG. 6 is a block diagram showing some of the components typically incorporated in at least some of the computer systems and other devices on which the system operates.

### DETAILED DESCRIPTION

The inventors have recognized that both conventional forms of access to health insurance information suffer from significant disadvantages. Searching for the information in the health plan's documentation can be difficult and tedious and beyond the capabilities of many patients since these documents can be long, complex, technical, and therefore hard to comprehend. Calling the health insurer's Customer Care Center can be tedious, involving long waiting times, navigation of automated interactive voice response (IVR) systems, and long conversation times with Customer Care representatives. Additionally, many Customer Call Centers are only available during limited operation hours.

As a result, the inventors have recognized that patients may not find the information they need, which prevents them from utilizing their health plan effectively, and from making the best decisions regarding their health, healthcare and finances.

Healthcare providers may also seek information about the patient's eligibility and benefits in order to verify the patient's coverage for the intended care before providing it. Providers have an additional channel to acquire such information electronically from the payer administrating the patient's health insurance plan. The Health Insurance Portability and Accountability Act of 1996 (HIPAA) obliges payers to provide healthcare providers with patients' eligibility and benefits information (as well as additional information) in real-time, through Electronic Data Interchange (EDI) transactions in a standard X12 format (known in the art as HIPAA transactions).

In 1979, the American National Standards Institute (ANSI) chartered the Accredited Standards Committee (ASC) X12 to develop uniform standards for the electronic data interchange (EDI) of business transactions. ASC X12 has since developed and currently maintains a standard format and syntax for HIPAA transactions, which includes code sets for different types of information that HIPAA transactions may contain, including codes for the sought medical service (for example, MRI, Dialysis, Newborn care, etc.). The X12 code set for medical services is called Service Type Codes (known in the art as X12 STC). More specifically, HIPAA transactions include a 270 request transaction for Eligibility and Benefits information sent to payers (known in the art as X12 270) and a 271 response transactions from payers, containing the Eligibility and Benefits information asked for in a X12 270 request (known in the art as X12 271).

An X12 270 includes one or more X12 STCs, which indicate a request for eligibility and benefits information associated with the medical service(s) the X12 STC(s) represent. The payer's X12 271 response may include eligibility and benefits information for the X12 STC(s) included in the X12 270 request and for additional X12 STC's that the patient is covered for, as well as plan level information. Such eligibility and benefit information may include the part of the cost that the patient should cover (for example co-insurance, co-payment, deductible, etc.).

Currently, only healthcare providers and clearing houses can obtain patients eligibility and benefits information through HIPAA transactions through Healthcare Information Systems (HIS), which they can either install in-house, or access remotely through the Internet. Patients cannot take advantage of HIPAA transactions to receive benefit and eligibility information.

Natural Language Processing (known in the art as NLP) technologies enable humans to interact with computers in natural language. Specifically, Natural Language Understanding (known in the art as NLU) technologies enable computers to derive meaning from natural language input, and more specifically, information extraction NLU technology enables computers to extract semantic (related to meaning) information from natural language textual input. For example, given the input “What are my benefits for MRI in an outpatient hospital?”, an NLU information extraction engine can extract “MRI” as a type of medical service, “outpatient hospital” as a place of service (the type of location where a medical service is provided), and “benefits” as a type of health insurance plan terms. Using NLU technology enables computers provided with a natural language eligibility and benefits inquiry text to automatically extract all the information necessary to answer the inquiry using HIPAA transactions.

In order to overcome the disadvantages of conventional forms of access to health insurance information, the inventors have conceived and reduced to practice a software and/or hardware system enabling patients, and other types of users, to obtain health insurance information—eligibility and benefits information—transactions through natural language inquiries.

The system enables users, including patients, care providers, payer representatives, etc., to submit benefit inquiries in every-day language, at any time, and receive answers in real-time. The system processes the inquiries, extracts the information required and generates a HIPAA X12 270 request, then submits it to the payer. On receipt of a corresponding HIPAA X12 271 response from the payer, the system extracts the relevant information from the X12 271 response, generates an answer, and returns the answer to the user.

For patients, the system offers a new way of obtaining eligibility and benefits information that, being based on natural language interaction, is easy and simple to use, faster, and available at any time. For healthcare providers the system offers a simpler and faster way of utilizing HIPAA transactions, which does not require special skills and is much closer to obtaining the information from a customer care representative.

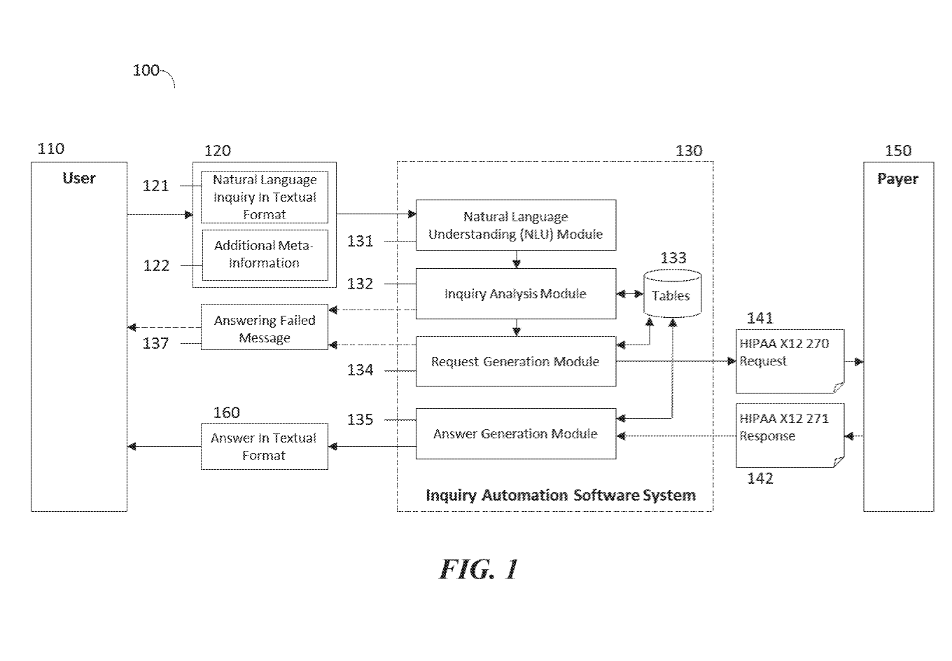

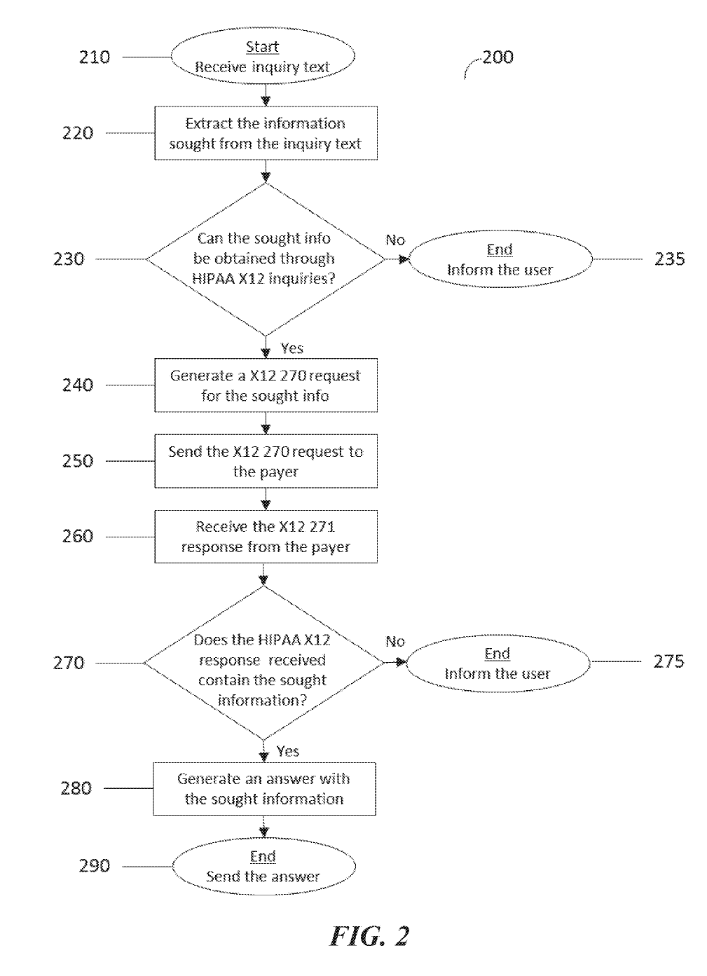

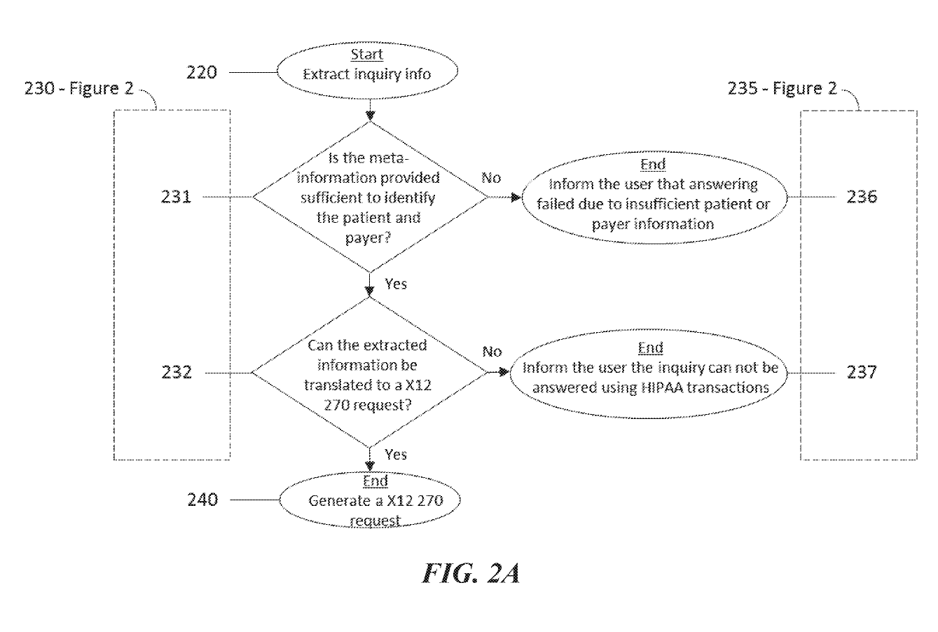

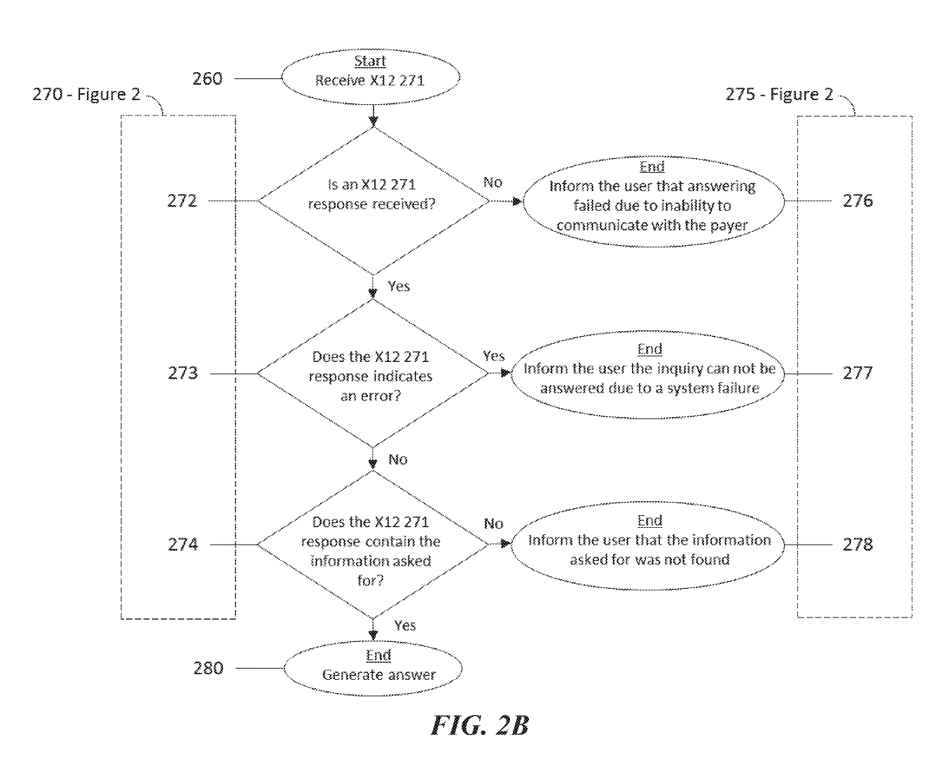

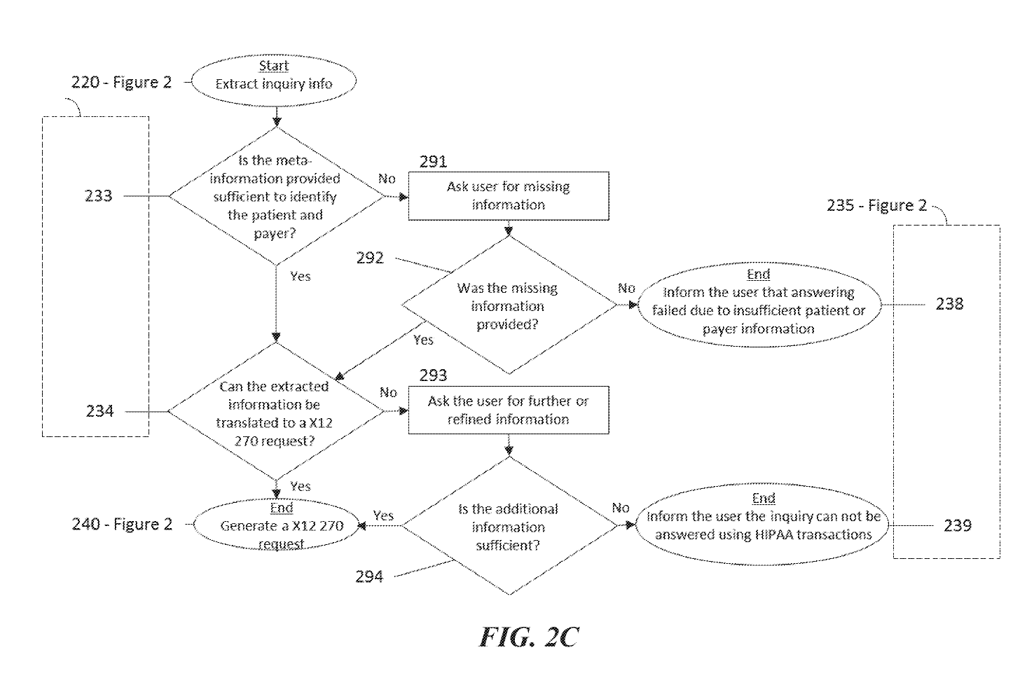

Referring to FIG. 1 and FIG. 2, the method 200 starts at OPERATION 210, when the system 130 receives an eligibility and benefits inquiry 120 from the user 110. The inquiry 120 should include the natural language inquiry text 121 and additional meta-information 122 that may include the patient health-plan ID, the patient's full name, the patient's date of birth, the applicable date of service (DOS), and the name of the payer that issued the health plan.

The Natural Language Understanding (NLU) software module 131 processes the inquiry text 121 and extracts the information necessary to generate an X12 270 request (OPERATION 220). The necessary information may include, but is not limited to:
The type of information sought:
   The patient's general eligibility—is the patient's health plan active on the DOS.
   The member's health plan effective/termination dates.
   The patient's health plan plan-level benefits, e.g., deductible, maximum out-of-pocket limit, individual/family, in-network/out-of-network.
   The amount/s already paid by the patient since the health plan's effective date.
   The number of units the patient has already utilized since the health plan's effective date, of medical services for which the member may be entitled to a limited number of units (such as Physical Therapy treatments, Annual Physical Examinations, Mammograms, etc.).
   The patient's health plan benefits associated with one or more medical services.
   The place of service in which the medical service/s for which the information is sought will be performed.
   The patient's health plan's preauthorization requirements associated with one or more medical services.
The medical service/s for which information is sought (such as MRI, Colonoscopy, Specialist Office Visit, etc.), if any.
The place of treatment/s for which information is sought (such as Outpatient Hospital, PCP Office, Ambulatory Surgical Center, etc.), if any.
The type of healthcare provider for which information is sought—in-network or out-of-network, if any.

For example, for an inquiry text 121 “What are my benefits for MRI in an outpatient hospital?” the NLU module 131 extracts “MRI” as a medical service, “outpatient hospital” as the place of service, and “benefits” as the health insurance benefits type sought for that medical service provided at this place of service. As another example, for an inquiry text 121 “Am I eligible for physical therapy?” the NLU module 131 extracts “physical therapy” as a medical service and “eligible” as the health insurance benefits type sought for that medical service.

The Inquiry Analysis software module 132 analyzes the information extracted from the inquiry text 121 by the NLU module 131, and the additional meta-information provided with the inquiry 122, and determines whether the information can be obtained by HIPAA Transactions (DECISION 230).

FIG. 2A further details DECISION 230 and OPERATION 235 illustrated in FIG. 2. The Inquiry Analysis module 132 first checks if the additional meta-information 122 included in the inquiry 120 satisfies the patient and payer identification requirements of an X12 270 request according to the then valid X12 guidelines regarding the format of the X12 270 request, which ASC X12 publishes from time to time (DECISION 231). If not, the system 130 sends the user a message 137 saying that answering failed due to missing required patient or payer identification information and the method 200 ends (OPERATION 236).

If yes, then the Inquiry Analysis module 132 checks if the information extracted from the inquiry text 121 by the NLU module 131 can be translated an X12 270 request (DECISION 232). If the information is sought for a medical service, it checks if the medical service for which the information is sought matches an X12 Service Type Code (X12 STC). For this purpose, it may use a lookup table 133 that maps medical services to X12 STC's. Following is an example of such a table, including examples of some of the entries the table may include:

Medical Services to X12 STC's Mapping
Table Example

| Medical Service | X12 STC |
|---|---|
| Health Benefit Plan coverage | 30 |
| Surgical | 2 |
| Consultation | 3 |
| Diagnostic X-Ray | 4 |
| Diagnostic Lab | 5 |
| Radiation Therapy | 6 |
| Psychotherapy | A6 |
| Occupational Therapy | AD |

Since X12 updates the list of X12 STC's from time to time, the system updates this table as needed.

If the information sought is a medical service and a match is not found, the system 130 sends the user a message 137 saying that answering failed since the inquiry cannot be answered using HIPAA transactions and the method 200 ends (OPERATION 237).

Referring now back to FIG. 1 and FIG. 2, if a match (or matches) is found, then the Request Generation software module 134 generates an X12 270 request 141 according to the then valid X12 guidelines regarding the format of the X12 270 request, which ASC X12 publishes from time to time (OPERATION 240).

The Request Generation software module 134 then sends the X12 270 request to the payer 150 that was specified in the additional meta-information 122 part of the inquiry 120 (OPERATION 250).

FIG. 2B further details DECISION 270 and OPERATION 275 illustrated in FIG. 2. The system 130 then waits for an X12 271 response from the payer 150. If a response (or all responses) is not received within a certain duration (for example, 20 second) (DECISION 272), the system 130 sends the user a message 137 saying that answering failed due to inability to communicate with the payer's system and the method 200 ends (OPERATION 276).

If the X12 271 142 is received from the payer 150, the Answer Generation software module 135 analyzes it according to the then valid X12 guidelines regarding the format of the X12 271 request, which ASC X12 publishes from time to time, and checks whether it indicates an error (DECISION 273). If the X12 271 response 142 indicates an error, the system 130 sends the user a message 137 saying that answering failed due to a system error and the method 200 ends (OPERATION 277).

If the X12 271 response 142 does not indicate an error, the Answer Generation software module 135 checks whether it contains the information asked for in the X12 270 request 141 (DECISION 274). For this purpose, the Answer Generation software module 135 may use tables 133 which map additional X12 codes to different types of information. Following is an example of such a table which maps some X12 benefit types codes to the type of benefits that X12 271 responses may include:

X12 Benefit type Table Example

| X12 Code | Benefit type |
|---|---|
| 1 | Active Coverage |
| 6 | Inactive Coverage |
| A | Co-Insurance |
| B | Co-Payment |
| C | Deductible |
| E | Exclusions |
| F | Limitation |
| G | Out-of-pocket Limit |

If the X12 271 response 142 does not contain the information asked for in the X12 270 request, the system 130 sends the user a message 137 saying that answering failed since the system could not find the requested information and the method 200 ends (OPERATION 278).

Referring now back to FIG. 1 and FIG. 2, if the X12 271 response 241 does contain the information asked for in the X12 270 request, then the Answer Generation software module 135 generates an answer in textual format 160 containing that information, sends the answer in textual format 160 back to the user and the method 200 ends (OPERATION 290). If multiple X12 271 responses 241 were received, then the Answer Generation software module 135 generates a single answer in textual format 160 aggregating all the information received in all of the X12 271 responses 241, sends the answer in textual format 160 back to the user and the method 200 ends (OPERATION 290).

### ADDITIONAL EMBODIMENTS

### Multiple HIPAA Transactions

Referring now to FIG. 1, FIG. 2 and FIG. 2A, after the Inquiry Analysis Module 131 determines that he meta-information 122 included in the inquiry 120 is sufficient to identify the patient and the payer in a X12 270 request, the Inquiry Analysis Module 131 checks if the inquiry seeks information for a medical service (DECISION 232). If information is sought for multiple medical services, then, the Request Generation software module 134 may generate multiple such X12 270 requests 141.

Since X12 271 responses may include information about additional medical services which were not specified in the X12 270 request, multiple X12 270 requests may not be needed even if the inquiry seeks information for multiple medical services.

Note that the medical services for which eligibility and benefits information is returned in a X12 271 response to a specific X12 270 request, and the types of information returned for each service, may change according to the latest ASC X12 standards version, and may defer among payers. For example, according to version X12 5010, some of the X12 STC's are grouped into high level categories, each of which has its own X12 STC. When an X12 270 request includes such a category level X12 STC, the X12 271 response may include information for all the X12 STC's that are included in that category group. For example, for a X12 270 requesting information about X12 STC 2 (Surgical), the X12 271 response may include information for X12 STC's 2 (Surgical), 7 (Anesthesia), 8 (Surgical Assistance) and 20 (Second Surgical Opinion). As another example, for a X12 270 requesting information about X12 STC 35 (Dental Care), the X12 271 response may include information for X12 STC's 35 (Dental Care), 23 (Diagnostic Dental), 24 (Periodontics), 25 (Restorative), 26 (Endodontics), 27 (Maxillofacial Prosthetics), 28 (Adjunctive Dental Services), 30 (Health Benefit Plan Coverage), 36 (Dental Crowns), 37 (Dental Accident), 38 (Orthodontics), 39 (Prosthodontics), 40 (Oral Surgery), and 41 (Routine (Preventive) Dental). Also, plan level benefits, like deductibles and out-of-pocket-limits, can be obtained through a X12 270 request for X12 STC 30 (Health Benefit Plan coverage), where the X12 271 response will include also information for a group of main medical services such as X12 STC 48 (Hospital Inpatient), 50 (Hospital Outpatient), 98 (Physician Office Visit), etc.

If the Request Generation Module 134 generates and send to the payer 150 multiple X12 270 requests 141 (OPERATION 250), then the system 130 waits for X12 271 responses 142 to all the X12 270 requests 141 sent to be received from the payer 150.

Referring now to FIG. 1, FIG. 2 and FIG. 2B, if any of the responses is not received within a certain duration (for example, 20 second) (DECISION 272), the system 130 sends the user a message 137 saying that answering failed due to inability to communicate with the payer's system and the method 200 ends (OPERATION 276).

If all X12 271 142 are received from the payer 150, the Answer Generation software module 135 analyzes them according to the then valid X12 guidelines regarding the format of the X12 271 request, which ASC X12 publishes from time to time, and checks whether any of them indicates an error (DECISION 273). If any of the X12 271 response 142 indicates an error, the system 130 sends the user a message 137 saying that answering failed due to a system error and the method 200 ends (OPERATION 277).

If none of the X12 271 response 142 indicates an error, the Answer Generation software module 135 checks whether they contain the information asked for in all of the X12 270 requests 141 sent (DECISION 274). If the X12 271 responses 142 do not contain the information asked for in all of the X12 270 requests sent, the system 130 sends the user a message 137 saying that answering failed since the system could not find all the requested information and the method 200 ends (OPERATION 278).

Referring now back to FIG. 1 and FIG. 2, if the X12 271 responses 241 do contain the information asked for in all the X12 270 requests sent then the Answer Generation software module 135 generates a single answer in textual format 160 aggregating all the information received in all of the X12 271 responses 241, sends the answer in textual format 160 back to the user and the method 200 ends (OPERATION 290)

### Dialogue Based System

Referring to FIG. 1 and FIG. 2, after the NLU module 131 extracts the information from the user inquiry 120 (OPERATION 220), the Inquiry Analysis module 132 analyzes the information extracted and determines whether an answer can be obtained using HIPAA X12 inquiries (DECISION 230).

FIG. 2C further details DECISION 230 and OPERATION 235 illustrated in FIG. 2. The Inquiry Analysis module 132 first checks if the additional meta-information 122 included in the inquiry 120 satisfies the patient and payer identification requirements of an X12 270 request according to the then valid X12 guidelines regarding the format of the X12 270 request, which ASC X12 publishes from time to time (DECISION 233). If not, the Inquiry Analysis module 132 asks the user for the missing information (OPERATION 291). It then checks if the missing information is provided (DECISION 292). If no, the Inquiry Analysis module 132 informs the user that answering failed due to insufficient patient or payer identification information and the method 200 ends (OPERATION 238).

If either the additional meta-information 122 included in the inquiry 120 satisfies the patient and payer identification requirements of an X12 270 request according to the then valid X12 guidelines (DECISION 233), or the missing information is provided by the user (DECISION 292), the Inquiry Analysis module 132 checks if the information extracted from the inquiry text 121 by the NLU module 131 can be translated into one or more X12 270 requests (DECISION 234). If not, the Inquiry Analysis module 132 asks the user for additional information (if needed) and/or for refinement of the inquiry (OPERATION 293). For example, if the information extracted from the inquiry 120 does not include a medical service, or a type of health-plan benefits (such as “benefits”, “co-insurance”, “coverage”, “deductible”, etc.), or another type of plan-level information (such as “effective date”, “termination date”, etc.), the Inquiry Analysis module 132 may ask the user for such information. As another example, if the inquiry 121 is “What are my DME benefits?”, and there are different X12 STC's for DME purchase and DME rental, the Inquiry Analysis module 132 may ask the user to choose between the two options (OPERATION 293). As another example, if the inquiry 121 is “Has my deductible been met?”, the Inquiry Analysis module 132 may ask the user to specify if by deductible the user meant individual or family deductible, and if it is for in-network or out-of-network medical services.

The Inquiry Analysis module 132 then determines if the additional information provided by the user is sufficient (DECISION 294). If no, the Inquiry Analysis module 132 informs the user that the inquiry cannot be answered using HIPAA transactions and the method 200 ends (OPERATION 239).

If either the information in the original inquiry 120 alone is sufficient to be translated into a X12 270 inquiry (DECISION 234), or that information together with the additional information provided by the user is sufficient (DECISION 294), then the Request Generation Module 134 generates a X12 270 request 141 according to the then valid X12 guidelines regarding the format of the X12 270 request, which ASC X12 publishes from time to time (OPERATION 240), and the method 200 proceeds as described in the Detailed Description Of The System section above.

### Speech Enabled System

In some embodiments, the system is speech enabled. Using Speech Recognition technology (known in the art as Speech to Text), users can speak their inquiries instead of typing them.

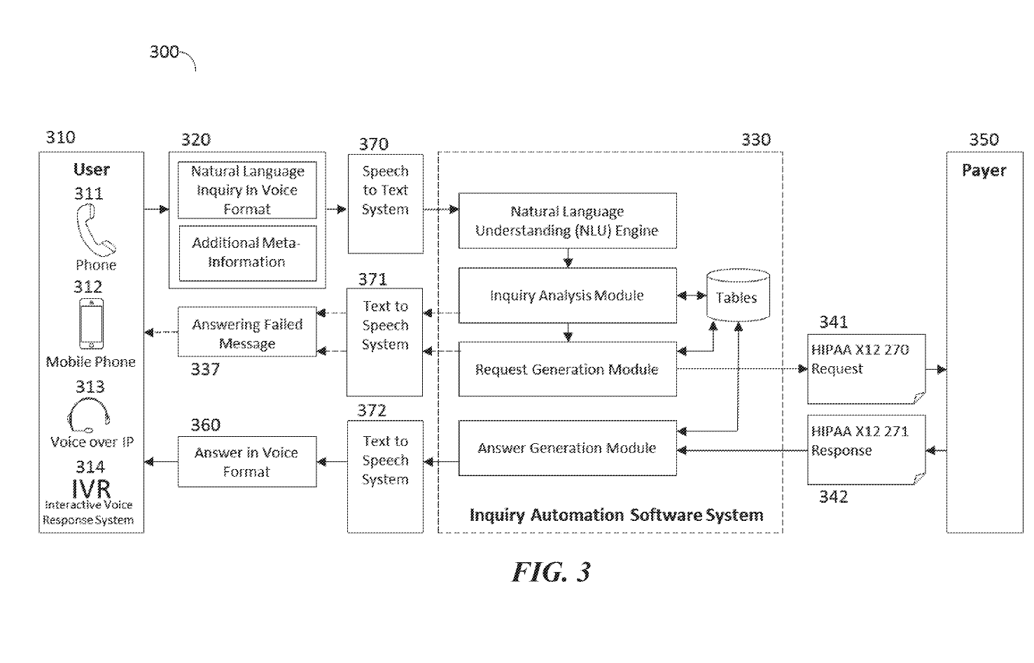

Referring now to FIG. 3, users can speak their inquiry using any speech enabled device, including but not limited to a Phone 311, a Mobile Phone 312 or Voice over IP 313 device (connected to any computer), and Interactive Voice Response (IVR) systems 314. A Speech to Text system 370 may convert the user's spoken words from voice format to textual format, which the system handles as described above.

Using a Speech Synthesizing technology (known in the art as Text to Speech), users may receive the system's output spoken. Any system message to the user, including Failure messages 337 and an answer to the inquiry 360, originally in textual format, may be converted to a voice format by a Text to Speech system, which can be played to the user.

### Additional Types Of Inquires Answered By The System

The System 430 can also be used to answer additional types of inquiries using additional HIPAA transaction types, as may be added to HIPAA Act from time to time.

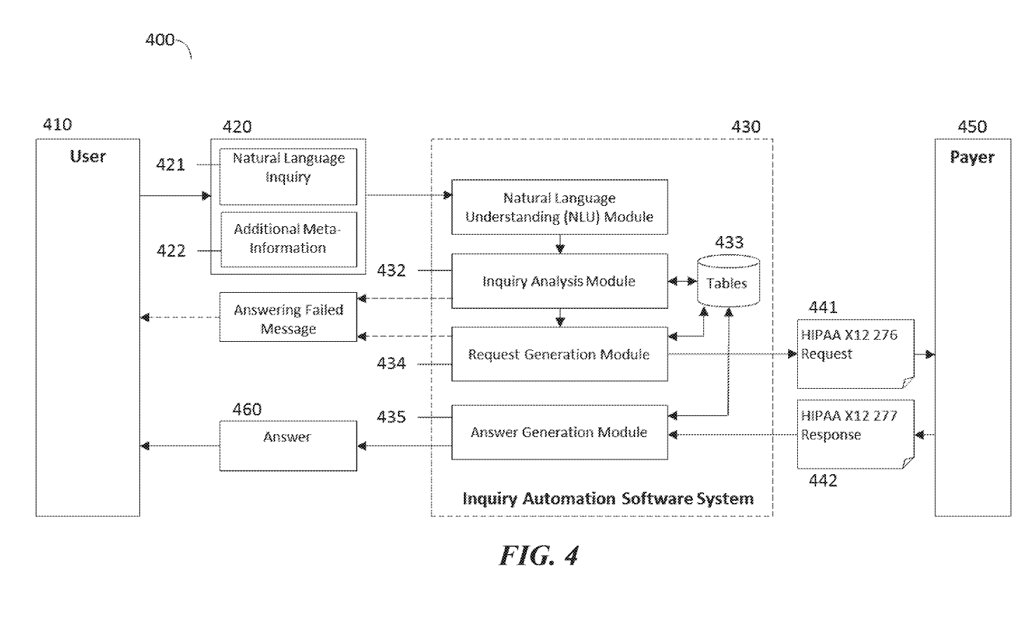

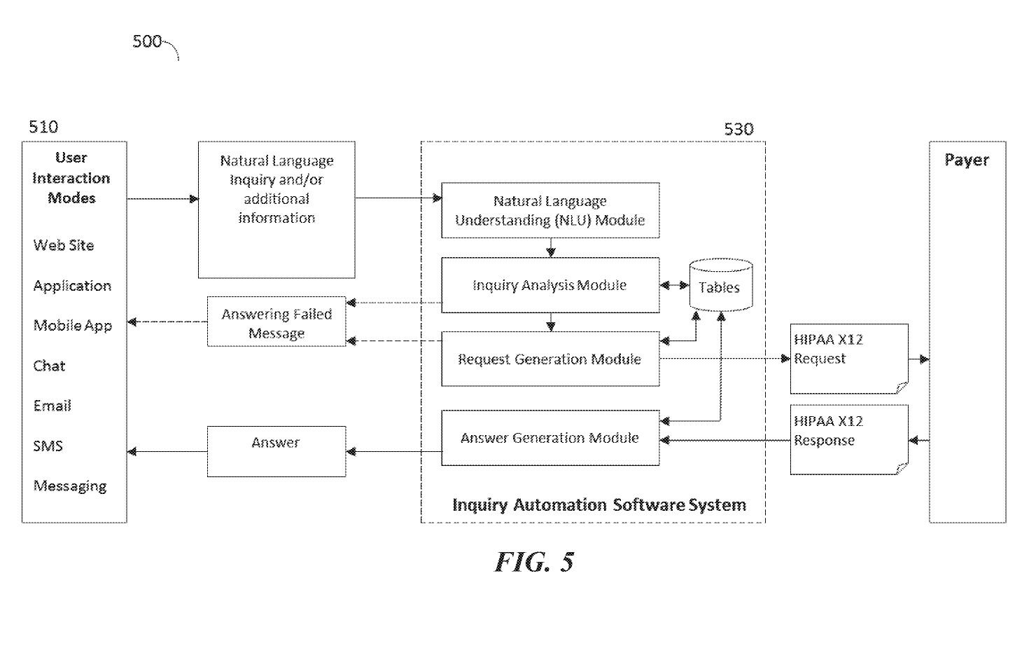

Referring to FIG. 4, for example, using HIPAA claim status information request transaction 276 (known in the art as X12 276) and response transaction 277 (known in the art as X12 277), the System answers natural language claim status inquiries.

Referring to FIG. 4, the Additional Meta-Information of a claim status inquiry 420 includes the required claim identification information. The Request Generation Module 434 will generate a X12 276 request according to the valid ASC X12 guidelines, and the Answer Generation Module 435 will receive a X12 277 response and translate it into an answer based on those guidelines.

### Different User Interaction Modes

The System 530 can interact with users in multiple modes 510, including but not limited to:
1. Web Site
2. Application
3. Mobile App
4. Chat
5. Email
6. SMS
7. Messaging

Users can use different interaction mode in a single inquiry session. For example, users can speak their inquiry using a Mobile App and receive the answer in an SMS and/or in an Email. cl ADDITIONAL EXAMPLES

Two additional examples of the operation of the system to process user inquiries follow:

### Example 1

### Inquiry About a Specific Medical Service

Inquiry: “What are my benefits for a knee surgery?”

System's processing of inquiry: comprehends that the inquiry is about the benefits for the medical service of a knee surgery, looks up an STC (Service Type Code) for a knee surgery and finds 2 (Surgical), then, generates a 270 request transaction for STC 2, sends it to the payer and waits for a response.

Payer's computer system: Receives the 270 transaction, extracts the benefits from its internal systems, translates the benefits information into a 271 response transaction, sends back the 271 response transaction.

System's processing of Payer's computer system's response: Receives the 271 response transaction, extracts the benefits information and returns to the user: “Knee surgery benefits: 40% coinsurance (after deductible).”

### Example 2

### Inquiry About Plan Terms

Inquiry: “What is my out of network deductible?”

System's processing of inquiry: comprehends that the inquiry is about the members deductible for out of network providers, looks up an STC and finds 30 (general plan info), then, generates a 270 request transaction for STC 30, sends it to the payer and waits for a response.

Payer's computer system: Receives the 270 transaction, extracts the plan info (including the deductible and remaining deductible amounts, in and out of network status, family and individual benefits) from its internal systems, translates the benefits information into a 271 response transaction, sends back the 271 response transaction.

System's processing of Payer's computer system's response: Receives the 271 response transaction, extracts the benefits information and returns to the user: “Your out-of-network individual deductible is $3000.00, with $683.00 remaining. Your out-of-network family deductible is $6,000.00, with $3,429.00 remaining”.

### Hardware

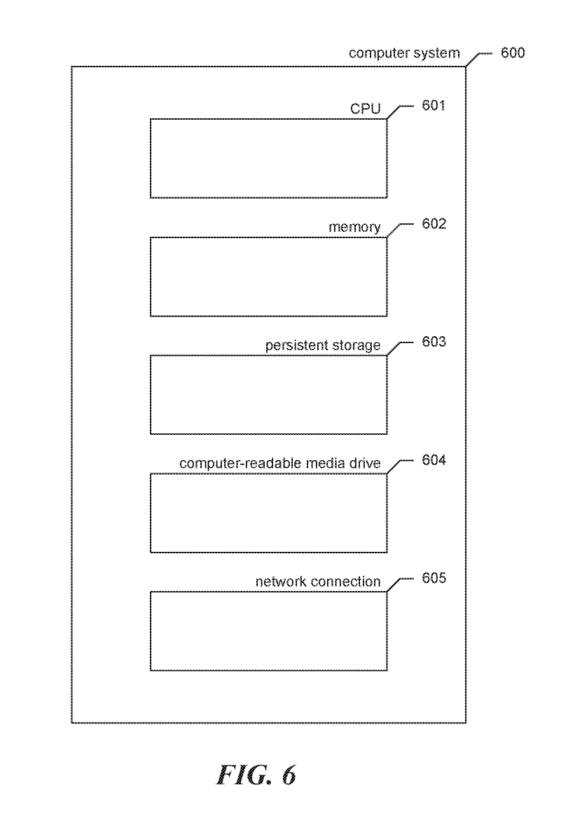

FIG. 6 is a block diagram showing some of the components typically incorporated in at least some of the computer systems and other devices on which the system operates. In various embodiments, these computer systems and other devices 100 can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (“CPU”) 601 for executing computer programs; a computer memory 602 for storing programs and data while they are being used, including the system and associated data, an operating system including a kernel, and device drivers; a persistent storage device 603, such as a hard drive or flash drive for persistently storing programs and data; a computer-readable media drive 604, such as a floppy, CD-ROM, or DVD drive, for reading programs and data stored on a computer-readable medium; and a network connection 605 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the system, those skilled in the art will appreciate that the system may be implemented using devices of various types and configurations, and having various components.

### Conclusion

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

1. A method in a computing system for respond to natural-language inquiries, the method comprising:
accessing a textual natural language inquiry originated by a user;
for each of one or more inquiry attributes, extracting from the textual natural language inquiry a value for the inquiry attribute;
using the extracted inquiry attribute values to construct one or more HIPAA X12 270 requests seeking information relevant to the inquiry;
submitting the constructed requests to a payer computer system;
in response to submission of the constructed requests, receiving from a payer computer system one or more HIPAA X12 271 responses; and
using information contained by at least one of the received HIPAA responses, generating a textual natural language response.

2. The method of claim 1, further comprising:
causing the generated textual natural language response to be displayed to the user.

3. The method of claim 1, further comprising:
receiving audio data representing speech of the user;
within the received audio data, recognizing the textual natural language query;
transforming the generated textual natural language response into a spoken audio representation; and
causing the spoken audio representation to be played to the user.

4. The method of claim 1 wherein the constructed requests are submitted on behalf of a patient,
and wherein the patient is the user.

5. The method of claim 1 wherein the constructed requests are submitted on behalf of a patient,
and wherein the patient is a person other than the user.

6. The method of claim 1, further comprising:
accessing meta-information describing the patient, and wherein the extraction of values of attributes of the inquiry is based in part on the accessed meta-information describing the patient.

7. The method of claim 1, further comprising:
accessing meta-information describing the patient, and wherein the generation of the HIPAA requests is based in part on the accessed meta-information describing the patient.

8. The method of claim 1, further comprising:
accessing meta-information describing the patient, and wherein the submission of the constructed requests is based in part on the accessed meta-information describing the patient.

9. The method of claim 1 wherein the inquiry is received via interactive voice response interactions, a web site, a mobile application, a desktop application, a chat message, a text message, or an email message.

10. The method of claim 1 wherein the extracting extracts a value for a medical service for which information is sought, a place of treatment for which information is sought, or a type of healthcare provider for which information is sought.

11. The method of claim 1 wherein the constructing accesses a mapping from service type names to HIPAA service type codes or a mapping from benefit& names to HIPAA benefit type codes.

12. The method of claim 1 wherein the generating comprises:
selecting one of a plurality of textual natural language response templates, the selected textual natural language response template containing one or more placeholders; and
replacing each of the placeholders contained by the selected textual natural language response template with text contained by at least one of the received HIPAA responses.

13. The method of claim 1 wherein the generated textual natural language response comprises a question about the inquiry to be answered by the user, the method further comprising:
accessing a textual natural language answer to the question originated by the user; and
using information contained by the textual natural language answer together with information contained by at least one of the received HIPAA responses to generate a second textual natural language response.

14. The method of claim 1 wherein the inquiry contains a code representing a category of medical services,
and wherein the generated textual natural language response include information about the category of medical services represented by the contained code.

15. A computer-readable medium having contents adapted to cause a computing system to, in order to respond to natural-language inquiries:
access a textual natural language inquiry originated by a user;
for each of one or more inquiry attributes, extract from the textual natural language inquiry a value for the inquiry attribute;
use the extracted inquiry attribute values to construct one or more HIPAA requests seeking information relevant to the inquiry;
submit the constructed requests to a payer computer system;
in response to submission of the constructed requests, receive from a payer computer system one or more HIPAA responses; and
use information contained by at least one of the received HIPAA responses to generate a textual natural language response.

16. The computer-readable medium of claim 15, the method further comprising:
cause the generated textual natural language response to be displayed to the user.

17. The computer-readable medium of claim 15 wherein the contents of the computer-readable medium further cause a computing system to:
receive audio data representing speech of the user;
within the received audio data, recognize the textual natural language query;
transform the generated textual natural language response into a spoken audio representation; and
cause the spoken audio representation to be played to the user.

18. The computer-readable medium of claim 15 wherein the constructed requests are submitted on behalf of a patient,
and wherein the patient is the user.

19. The computer-readable medium of claim 15 wherein the constructed requests are submitted on behalf of a patient,
and wherein the patient is a person other than the user.

20. The computer-readable medium of claim 15 wherein the contents of the computer-readable medium further cause a computing system to:
access meta-information describing the patient,
and wherein the extraction of values of attributes of the inquiry is based in part on the accessed meta-information describing the patient.

21. The computer-readable medium of claim 15 wherein the contents of the computer-readable medium further cause a computing system to:
access meta-information describing the patient,
and wherein the generation of the HIPAA requests is based in part on the accessed meta-information describing the patient.

22. The computer-readable medium of claim 15 wherein the contents of the computer-readable medium further cause a computing system to:
access meta-information describing the patient,
and wherein the submission of the constructed requests is based in part on the accessed meta-information describing the patient.

23. The computer-readable medium of claim 15 wherein the inquiry is received via interactive voice response interactions, a web site, a mobile application, a desktop application, a chat message, a text message, or an email message.

24. The computer-readable medium of claim 15 wherein the extracting extracts a value for a medical service for which information is sought, a place of treatment for which information is sought, or a type of healthcare provider for which information is sought.

25. The computer-readable medium of claim 15 wherein the constructing accesses a mapping from service type names to HIPAA service type codes or a mapping from benefit& names to HIPAA benefit type codes.

26. The computer-readable medium of claim 15 wherein the generating comprises:
selecting one of a plurality of textual natural language response templates, the selected textual natural language response template containing one or more placeholders; and
replacing each of the placeholders contained by the selected textual natural language response template with text contained by at least one of the received HIPAA responses.

27. The computer-readable medium of claim 15 wherein the generated textual natural language response comprises a question about the inquiry to be answered by the user,
wherein the contents of the computer-readable medium further cause a computing system to:
access a textual natural language answer to the question originated by the user; and
use information contained by the textual natural language answer together with information contained by at least one of the received HIPAA responses to generate a second textual natural language response.

28. The computer-readable medium of claim 15 wherein the inquiry contains a code representing a category of medical services,
and wherein the generated textual natural language response include information about the category of medical services represented by the contained code.

29. One or more memories collectively storing a data structure representing a natural language inquiry into health insurance information, the data structure comprising:
for each of one or more inquiry attributes, a value extracted for the inquiry attribute from a natural language inquiry originated by a user,
such that the inquiry attribute values contained by the data structure are usable to form HIPAA requests whose responses are useful to respond to the inquiry.

30. The memories of claim 26 wherein the data structure further comprises:
one or more pieces of meta-information describing a patient to whom the inquiry relates.
